(19) United States
(12) Patent Application Publication
(10) Pub. No.: US 2025/0347589 A1
(43) Pub. Date: Nov. 13, 2025

(54) DEVICE AND COMPUTER-IMPLEMENTED METHOD FOR MACHINE LEARNING

(71) Applicant: Robert Bosch GmbH, Stuttgart (DE)

(72) Inventor: Christoph Zimmer, Stuttgart (DE)

(21) Appl. No.: 19/184,768

(22) Filed: Apr. 21, 2025

(30) Foreign Application Priority Data
May 7, 2024 (DE) 10 2024 204 291.9

(51) Int. Cl. G01M 15/10; G05B 17/02

(52) U.S. Cl. CPC G01M 15/102; G05B 17/02

(57) ABSTRACT

A device and computer-implemented method for machine learning. A data set is provided, in which a measurement of an operating variable of a technical system is assigned in each case to a control variable of the technical system. Parameters of a hybrid model are learned according to the data set. A control variable of the technical system is determined according to a measure, which is dependent on the control variable, for an information gain in a measurement of the operating variable of the technical system when the technical system is operated with the control variable, and according to a probability that the operation of the technical system with the control variable is safe.

### CROSS REFERENCE

The present application claims the benefit under 35 U.S.C. § 119 of German Patent Application No. DE 10 2024 204 291.9 filed on May 7, 2024, which is expressly incorporated herein by reference in its entirety.

### BACKGROUND INFORMATION

Hybrid models can be used in machine learning. “Universal Differential Equations for Scientific Machine Learning,” Christopher Rackauckas, Yingbo Ma, Julius Martensen, Collin Warner, Kirill Zubov, Rohit Supekar, Dominic Skinner, Ali Ramadhan, Alan Edelman, (arXiv:2001.04385) describes an example of a hybrid model.

### SUMMARY

A device and the computer-implemented method for machine learning according to example embodiments of the present invention make the exploration of new measured values in a technical system possible, wherein unsafe states of the technical system, for example states that damage or destroy the technical system, are avoided.

According to an example embodiment of the present invention, the method provides that a data set is provided, in which a measurement of an operating variable of the technical system, in particular a noisy measurement of the operating variable, is assigned in each case to a control variable of the technical system, wherein parameters of a hybrid model, in particular a hybrid differential equation, are learned according to the data set, wherein the hybrid model comprises a physical model and a data-based model, wherein the physical model is designed to determine a first part of a temporal change in the operating variable of the technical system, wherein the data-based model is designed to determine a second part of the temporal change in the operating variable of the technical system, wherein a control variable of the technical system is determined according to a measure, which is dependent on the control variable, for an information gain in a measurement of the operating variable of the technical system if the technical system is operated with the control variable, and according to a probability that the operation of the technical system with the control variable is safe, wherein a measurement of the operating variable assigned to the control variable, in particular a noisy measurement of the operating variable, is recorded during operation of the technical system with the control variable, wherein the control variable and the measurement assigned to the control variable are added to the data set, and wherein parameters of the hybrid model are learned with the data set to which the control variable and the measurement assigned to the control variable are added.

For example, it is provided that the technical system comprises a computer-controlled machine, in particular a robot, preferably a vehicle, a household appliance, a motorized tool, a manufacturing machine, a personal assistance system or an access control system, or that the technical system comprises a test bench, in particular for a computer-controlled machine, in particular a robot, preferably a vehicle, a household appliance, a motorized tool, a manufacturing machine, a personal assistance system or an access control system.

For example, the test bench is designed to operate an internal combustion engine, wherein the internal combustion engine is designed to combust an air-fuel mixture according to the control variable, wherein the measurement assigned to the control variable characterizes an operating variable of the internal combustion engine, in particular a noise emission or a pollutant emission of the internal combustion engine, in particular wherein the internal combustion engine is designed to ignite the air-fuel mixture with a pilot ignition and a main ignition, wherein the control variable comprises a time between a pilot ignition and a main ignition, and/or wherein the internal combustion engine is designed to provide fuel at a pressure in a distributor pipe of the internal combustion engine, wherein the control variable comprises the pressure, and/or wherein the internal combustion engine is designed to inject a quantity of fuel, wherein the control variable comprises the quantity of fuel.

For example, the technical system is operable in a first operating state in which the technical system is used for an intended purpose according to the hybrid model, wherein the technical system is operable in a second operating state in which the technical system is not usable for the intended purpose, and wherein the control variable and/or the measurement assigned to the control variable and/or the data set that comprises the control variable and the measurement assigned to the control variable is determined in the second operating state.

For example, the parameters of the hybrid model in the second operating state are learned with the data set that comprises the control variable and the measurement assigned to the control variable.

For example, according to an example embodiment of the present invention, it is provided that, in the first operating state, a determination of the control variable, and/or the measurement assigned to the control variable, and/or the data set that comprises the control variable and the measurement assigned to the control variable, and/or the learning of the parameters of the hybrid model with the data set that comprises the control variable and the measurement assigned to the control variable, is omitted.

For example, according to an example embodiment of the present invention, it is provided that the control variable is determined for which the measure of the information gain is greater than for another control variable and for which the probability that the operation of the technical system with the control variable is safe is greater than a threshold value.

For example, according to an example embodiment of the present invention, it is provided that the measure for the information gain comprises a first matrix that comprises a time series of measurements and a set of values of the change in the operating variable of the data-based model, wherein the operating variable to be measured is determined according to a determinant of a second matrix, wherein the determinant of the second matrix approximates a determinant of the first matrix.

For example, according to an example embodiment of the present invention, it is provided that the elements of the second matrix are defined by the covariance of values of the change in the operating variable according to values of the time series.

A device for machine learning according to an example embodiment of the present invention comprises at least one processor and at least one memory, wherein the at least one processor is designed to execute instructions, upon execution of which by the at least one processor the device carries out the method according to the present invention, wherein the at least one memory stores the instructions.

A computer program comprising computer-executable instructions, upon execution of which by the computer the computer carries out the method of the present invention, can be provided.

Further advantageous embodiments of the present invention can be found in the following description and the figures.

### BRIEF DESCRIPTION OF THE DRAWINGS

FIG. 1 is a schematic representation of a first example of a device for machine learning, according to the present invention.

FIG. 2 is a flow chart of a first example of a method for machine learning, according to the present invention,

FIG. 3 is a schematic representation of a second example of the device for machine learning, according to the present invention.

FIG. 4 is a flow chart of a second example of the method for machine learning, according to the present invention.

### DETAILED DESCRIPTION OF EXAMPLE EMBODIMENTS

A device for machine learning comprises at least one processor 102 and at least one memory 104.

Operating variables of a technical system x that are influenced by a control variable c of the technical system are used for machine learning.

A hybrid model

$$dx / dt = f ( c , x ) + g ( c , x )$$

for a temporal change dx/dt in the operating variable x of the technical system comprises a physical model f(c, x) for a part of the temporal change dx/dt in the operating variable x according to the control variable c and a data-based model g(c, x) for a part of the temporal change dx/dt in the operating variable x. The data-based model g(c, x) comprises e.g. a Gaussian process defined by hyperparameters of the Gaussian process.

For an operating variable x for which the physical model f(c, x) is not known, it can be provided to determine the part of the temporal change dx/dt in the operating variable x independently of the physical model f(c, x), e.g. by f(c, x)=0.

For an operating variable x for which the physical model f(c, x) is known, it can be provided to determine the part of the temporal change dx/dt in the operating variable x according to the physical model f(c, x)

For the machine learning, it can be provided to leave the physical model f(c, x) unchanged.

The machine learning is based on the fact that m initial time series y₁_{ⁱ}, . . . , yₙ_{ⁱ}, i=1, . . . m and measurements yⱼ_{ⁱ}=xⱼ_{ⁱ}+ϵ of the operating variable xⱼ_{ⁱ} of the technical system, which are additively loaded with independently and identically distributed noise ϵ, exist.

The measurements yⱼ_{ⁱ} are noisy measurements of an operating variable xⱼ_{ⁱ} of the technical system that occurs during operation of the technical system with the control variable c.

In the machine learning, an exploration is provided by a new measurement y* for a new control variable c*, which determines how the operating variable xⱼ_{ⁱ} develops over time according to dx/dt=f(c, x)+g(c, x).

In one example, the control variable c characterizes an initial state x(t₀)=c of the technical system.

In one example, the control variable c characterizes parameters of a controller that controls the technical system.

In one example, the control variable c characterizes a control strategy or a control function. The example provides that the physical model f(x, c) implements the control strategy or control function.

In the case in which the physical model f(c, x) is not known, i.e. f(x)=0, the procedure for machine learning with M time series is e.g. as follows:
1 For i=m+1: M
2 Learn the data-based model for the differential equation

$$\frac{dx}{dt} = g ( {c}_{j} , x )$$

according to a data set D={cⱼ, yⱼ_{ⁱ}} that comprises the control variables cⱼ and measurements yⱼ_{ⁱ} assigned to the respective control variables cⱼ, wherein the measurements yⱼ_{ⁱ} were recorded during a development of the real existing technical system according to the particular control variable cⱼ. For example, the hyperparameters of the Gaussian process are learned.
3 Identify a control variable c* that allows the greatest possible information gain and for which the technical system is likely to operate safely.

In the example, a measure for the information gain I(c) is provided. The measure for the information gain I(c) in the example is a first matrix, which comprises a time series of n measurements y₁, . . . , yₙ and a change in the operating variable g(x)_{(x∈x)} determined with the data-based model according to the variable c:

$$I ( c ) = det ( I ( {y}_{1} , … , {y}_{n} ; {g ( x )}_{\{ x ∈ X \}} )$$

wherein c represents the possible control variable of the technical system to be evaluated.

In the example, the determinant detI of the first matrix I is approximated by a determinant detA of a second matrix A.

$$det ( I ( {y}_{1} , … , {y}_{n} ; {g ( x )}_{\{ x ∈ X \}} ) \sim det A$$

$$wherein$$

$${A}_{ij} = {\int }_{{t}_{i - 1}}^{{t}_{i}} {\int }_{{t}_{k - 1}}^{{t}_{k}} Cov [ g ( x ( t ) , c ) g ( x ( s ) , c ) ] dtds$$

wherein Cov represents the covariance and tᵢ represents the point in time that corresponds with the measurement yᵢ.

In the example, x(t) is unknown.

In one example, x(t) is determined by a mean field approximation, i.e. by a solution of

$$\frac{dx}{dt} = g ( x )$$

with the data-based model g(x) with the currently learned hyperparameters.

In one example, Aᵢⱼ is determined, wherein

K trajectories x^{k}(t), k=1, . . . , M of the control variable c are drawn with x^{k}(t{+1})=x^{k}(t{i})+g(c, x^{k}({i})) and Aᵢⱼ is determined according to the drawn trajectories x^{k}(t), k=1, . . . , M.

For example, the control variable is c* determined, which provides a greater information gain than other possible control variables.

For example, the control variable c* is determined according to the probability P(c) that the operation of the technical system with the control variable c* is safe.

For example, the control variable c* that meets the following conditions is determined:

$${c}^{*} = arg {max}_{c} I ( c )$$

$$P ( c > 0 ) > α$$

wherein α defines a threshold value for the probability P(c>0) at which it is assumed that the operation of the technical system with the control variable c* is safe.

For example

$$P ( c > 0 ) = {\int }_{{y}_{1} , … , {y}_{{n}_{d}}} {1}_{Z = ξ ( {y}_{1} , … , {y}_{{n}_{d}} ) > 0} N ( {y}_{1} , … , {y}_{{n}_{d}} \vert μ ( D ) , \sum ( D ) ) {dy}_{1} , … , {y}_{{n}_{d}}$$

In the example, x(t) is unknown.

In one example, x(t) is determined by the described mean field approximation, wherein the uncertainty of a step is taken into account by g(x(rᵢ, c)).
4. Output the control variable c*.

Measurements y*^{,i} are recorded in response to the output of the control variable c*. The measurements y*^{,i} are recorded during operation of the real existing technical system with the control variable c*. The measurements y*^{,i} are recorded e.g. automatically or by a user of the technical system
5. Update the data set with the control variable c* and the measurements y*^{,i} assigned to the control variable c*, e.g.:

$$D = \{ {c}_{j} , {y}_{j}^{i} \} ⋃ \{ {c}^{*} , {y}^{* , i} \}$$

6. End for

Other conditions can also be taken into account. For example, a condition for the control variable c, which is observed during the calculation, can be specified. For example, a range is specified in which it is too uncertain to carry out the exploration. An example of a control variable as an initial value for a range is

$$max ( var ( g ( x ( {r}_{1} , c ) ) ) , … , var ( g ( x ( {r}_{{n}_{d}} , x ) ) ) ) < {m}_{v}$$

wherein mᵥ is a threshold value that the predicted variances var along the trajectories from the mean field approximation must not exceed. For example, a condition is specified for the gradients of the state x(t), for example

$$max ( grad ( x ( {r}_{1} , c ) ) , … , grad ( x ( {r}_{{n}_{d}} , x ) ) ) < {m}_{g}$$

wherein m_{g} is a threshold value that the predicted gradients grad along the trajectories from the mean field approximation must not exceed.

In the case that the physical model f(x) is taken into account, the method is carried out accordingly, since f is deterministic, and Cov(f+g)=0, wherein only f is taken into account for the mean field approximation.

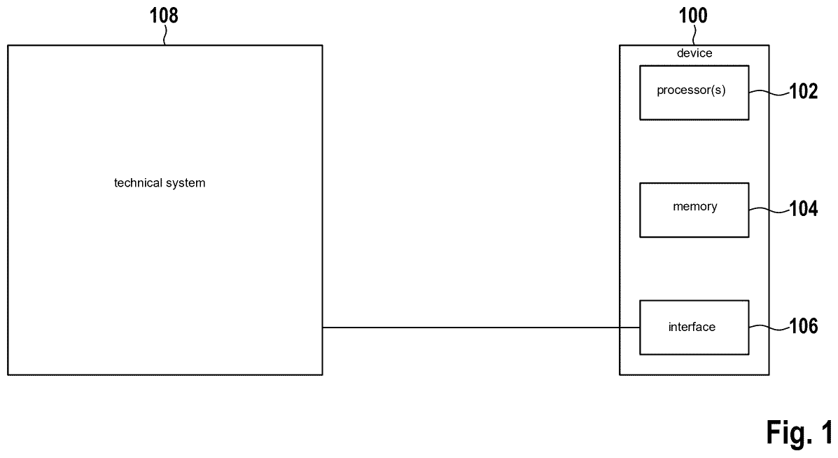

A first example of a device 100 for machine learning is shown schematically in FIG. 1.

The device 100 according to the first example comprises at least one processor 102 and at least one memory 104. The at least one memory 104 comprises e.g. non-volatile memory and volatile memory.

The device 100 comprises an interface 106 for communication with a technical system 108. The interface 106 is designed to receive measurements y*^{,i} from the technical system 108. The interface 106 is designed to transmit the control variables c* to the technical system 108.

The technical system 108 comprises a test bench in the example.

In the example, the test bench is designed to test an internal combustion engine.

The internal combustion engine is designed to burn an air-fuel mixture according to the control variable c*.

In one example, the internal combustion engine is designed to ignite the air-fuel mixture with a pilot ignition and a main ignition.

In one example, the control variables c* comprise a time between the pilot ignition and the main ignition.

In one example, the internal combustion engine is designed to provide fuel at a pressure in a distributor pipe of the internal combustion engine.

In one example, the control variable c* comprises the pressure.

In one example, the internal combustion engine is designed to inject a quantity of fuel.

In one example, the control variable c* comprises the quantity of fuel.

In one example, the control variable c* defines an initial state x of the internal combustion engine for performing the measurements y*^{,i}.

The control variable c* defines e.g. the initial time between the pilot ignition and the main ignition, or the initial pressure in the distributor pipe of the internal combustion engine for fuel, or the initial quantity of fuel.

The control variable c* defines e.g. the control parameters of a controller of the internal combustion engine, which controls the internal combustion engine during the performance of the measurement.

The test bench can be designed for testing another technical system, e.g. a computer-controlled machine, in particular a robot, preferably a vehicle, a household appliance, a motorized tool, a manufacturing machine, a personal assistance system or an access control system. An example of a vehicle is an excavator. For example, a calibration of the excavators is performed individually at the end of a production line on which the excavators are produced with the aid of the model created above. For calibration, measurements are performed e.g. for the parameter of the excavator to be calibrated. Based on these measurements, a hybrid model that can be used to support calibration can be trained.

The test bench is designed for measuring an operating variable of the internal combustion engine. The measurements y*^{,i} are e.g. noisy measurements of the operating variable. The operating variable characterizes e.g. a noise emission or a pollutant emission of the internal combustion engine.

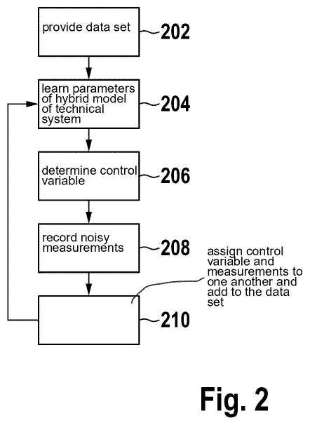

FIG. 2 shows a flow chart of a first example of a method for machine learning.

The method according to the first example is described using the test bench as an example.

The method according to the first example comprises a step 202.

In step 202, the data set D is provided, in which, in each case, noisy measurements

$${y}_{j}^{i}$$

of an operating variable x of the technical system 108 are assigned to a control variable cⱼ of the technical system 108, e.g. of the internal combustion engine.

The method according to the first example comprises a step 204.

In step 204, parameters of a hybrid model of the technical system 108, in particular a hybrid differential equation dx/dt=f(c, x)+g(c, x), are learned according to the data set D.

The hybrid model comprises a physical model f(c, x) of the technical system 108 and a data-based model g(c, x) of the technical system.

The physical model f(c, x) is designed to determine a first part of a temporal change dx/dt in the operating variable x of the technical system 108.

The data-based model f(c, x) is designed to determine a second part of the temporal change dx/dt in the operating variable x of the technical system 108.

The method according to the first example comprises a step 206.

In step 206, a control variable c* of the technical system 108 is determined.

The control variable c* of the technical system 108 is determined according to the measure I(c) for the information gain.

The control variable c* of the technical system 108 is determined according to the probability P(c) that the operation of the technical system 108 with the control variable c* is safe.

In the example, the control variable c* is determined for which the measure I(c*), which is dependent on the control variable c*, for the information gain is greater than for other possible control variables c, and for which the probability P(c*>0) that the operation of the technical system 108 with the control variable c* is safe is greater than a specified threshold value. The threshold value e.g. for a probability that indicates with 100% certainty that the operation is safe, is between 95% and 99.999%, in particular 95%, 97%, or 99%.

The method according to the first example comprises a step 208.

In step 208, noisy measurements y*^{,i} of the operating variable x assigned to the control variable c* are recorded during operation of the technical system 108 with the control variable c*.

The method according to the first example comprises a step 210.

In step 210, the control variable c* and the measurements y*^{,i} are assigned to one another and added to the data set D.

Subsequently, step 204 is executed again.

This means that when step 204 is executed again, the parameters of the hybrid model are learned with the data set D which comprises the control variable c* and the measurements y*^{,i} assigned to the control variable c*.

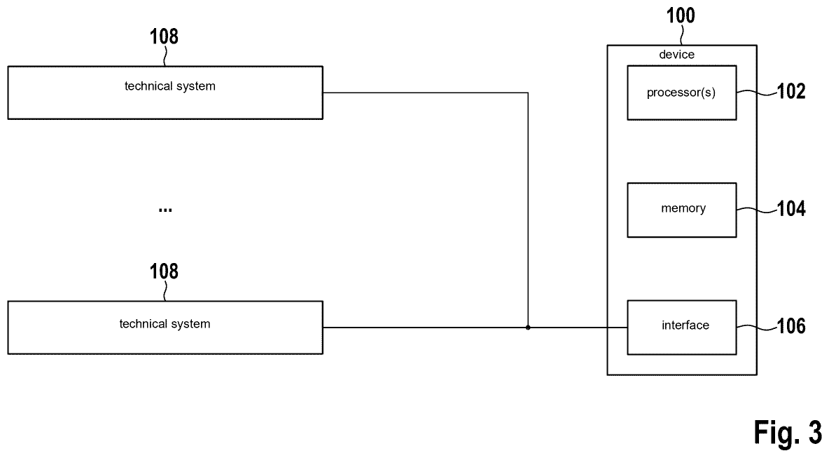

FIG. 3 schematically shows a second example of the device 100 for machine learning.

The device 100 according to the second example is designed as described for the first example.

In contrast to the device 100 according to the first example, the interface 106 of the device 100 according to the second example is designed to communicate with a plurality of technical systems 108, in order to transmit the control variable c* to the respective technical systems 108 and to receive respective measurements y*^{,i} recorded during operation of the particular technical system 108 with the particular control variable c*.

The particular technical system 108 is designed to receive the particular control variable c*, to record the respective measurements y*^{,i} during operation of the particular technical system 108 with the particular control variable c*, and to transmit the respective measurements y*^{,i} to the interface 106.

The technical system 108 according to the second example is a computer-controlled machine.

The technical system 108 according to the second example can comprise a robot.

The technical system 108 according to the second example can comprise a vehicle, a household appliance, a motorized tool, a manufacturing machine, a personal assistance system or an access control system.

The respective technical systems 108 can be operated in the field.

The respective technical systems 108 are e.g. operable in a first operating state, in which the particular technical system 108 is used for an intended purpose according to the hybrid model.

The respective technical systems 108 are e.g. operable in a second operating state, in which the particular technical system 108 cannot be used for the intended purpose.

The respective technical systems 108 are e.g. designed to receive the control variable c* in the second operating state

The respective technical systems 108 are e.g. designed in such a way that a receipt of the control variable c* in the first operating state is omitted.

The respective technical systems 108 are e.g. designed to measure the measurements y*^{,i} assigned to the control variable c* in the second operating state.

The respective technical systems 108 are e.g. designed in such a way that a measurement based on the control variable c* in the first operating state is omitted.

The respective technical systems 108 are e.g. designed to transmit the measurements y*^{,i} assigned to the control variable c* in the second operating state.

The respective technical systems 108 are e.g. designed in such a way that a transmission of the measurements y*^{,i} assigned to the control variable c* in the first operating state is omitted.

The respective technical systems 108 can be designed, instead of receiving the control variable c*, to determine the control variable c*, in particular in the second operating state. The respective technical systems 108 are e.g. designed in such a way that a determination of the control variable c* in the first operating state is omitted.

The respective technical systems 108 can be designed to add the control variable c* and the measurement y*^{,i} assigned to the control variable c* to a local data set instead of transmitting the measurements y*^{,i} assigned to the control variable c* in the second operating state. The respective technical systems 108 can be designed to transmit the local data set, e.g. after a plurality of measurements for a plurality of control variables to be measured, to the device 100. The device 100 can be designed to receive the particular local data set and to add it to the data set D.

The device 100 according to the second example is e.g. designed to learn the parameters of the hybrid model with the data set D.

The respective technical systems 108 can be designed, according to the second example, to learn the respective local parameters of a particular local hybrid model with the local data set. The device 100 can be designed to receive the respective local parameters and to determine the parameters of the hybrid model according to the local parameters.

The device 100 according to the second example is e.g. designed to transmit the learned parameters of the hybrid model to the respective technical systems 108. The respective technical systems 108 are e.g. designed to exchange the local parameters of the local hybrid model with parameters received from the device 100, in particular in the second operating state.

The respective technical systems 108 are designed in the example in such a way that the determination of the local parameters is omitted in the first operating state. The respective technical systems 108 are designed in the example in such a way that the exchange of the local parameters with the parameters received from the device 100 is omitted in the first operating state.

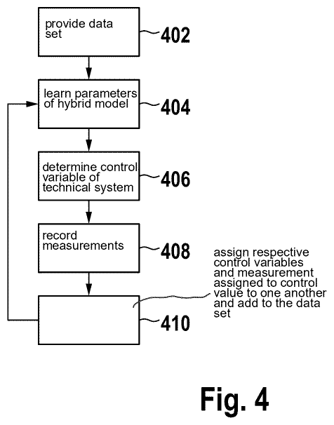

FIG. 4 shows a flow chart of a second example of a method for machine learning.

The method according to the second example is described using the example of a plurality of technical systems 108.

The method according to the second example comprises a step 402. In step 402, the data set D is provided, in which, in each case, noisy measurements yⁱ of an operating variable x of the technical system 108 are assigned to an initial value x₀ of a control variable c of the technical system 108, e.g. of the internal combustion engine.

The method according to the second example comprises a step 404.

In step 404, parameters of a hybrid model, in particular a hybrid differential equation dx/dt=f(c, x)+g(c, x), are learned according to the data set D. In the example, the hybrid model models the respective technical systems 108.

The hybrid model comprises a physical model f(c, x) of at least part of the technical system 108 and a data-based model g(c, x) of at least part of the technical system 108.

The physical model f(c, x) is designed to determine a first part of a temporal change dx/dt in the operating variable x of the technical system 108.

The data-based model f(c, x) is designed to determine a second part of the temporal change dx/dt in the operating variable x of the technical system 108.

In the example, each of the technical systems 108 is modeled with the same hybrid model, the same physical model f(c, x) and the same data-based model g(c, x). This means that a hybrid model is learned, each of which models at least the part of the technical systems 108. The technical systems 108 themselves do not have to be identical, but can also be of the same kind, i.e. similar enough to be modeled with the same hybrid model. It can be provided to train a separate hybrid model for each technical system 108 or for a plurality of technical systems 108, or a shared hybrid model for a plurality of technical systems 108.

The method according to the second example comprises a step 406.

In step 406, a control variable c* of the particular technical system 108 is determined. It can be provided to determine different control variables c*, or the same control variable c* for a plurality of or all technical systems 108.

In the example, the particular control variable c* defines the initial value x₀.

The control variable c* is determined according to the measure I(c) for the information gain if the particular technical system 108 is operated with the control variable c.

The control variable c* of the particular technical system 108 is determined according to the probability P(c) that the operation of the particular technical system 108 with the control variable c is safe.

In the example, the control variable c* is determined for which the measure I(c*), which is dependent on the control variable c*, for the information gain is greater than for other possible control variables c, and for which the probability P(c*>0) that the operation of the particular technical system 108 with the control variable c* is safe is greater than a specified threshold value. The threshold value e.g. for a probability that indicates with 100% certainty that the operation is safe, is between 95% and 99.999%, in particular 95%, 97%, or 99%.

It can be provided to determine the same measure and the same probability for a technical system 108 and to use them for all technical systems 108 or for a plurality of technical systems 108.

The method according to the first example comprises a step 408.

In step 408, measurements y*^{,i} of the operating variable assigned to the control variable c* are recorded during operation of the technical system 108 with the control variable c*.

This means that the respective technical systems 108 receive the control variable c* provided for the particular technical system 108 from the device 100, determine the measurements y*^{,i} during operation of the particular technical system 108 with the particular control variable c*, and transmit the measurements y*^{,i} to the device 100.

It can be provided that a plurality of control variables

$${c}_{j}^{*}$$

to be measured are transmitted and a plurality of measurements

$${y}_{j}^{* , i}$$

assigned to them in each case are measured during operation of the particular technical system 108 with the particular control variable

$${c}_{j}^{*}$$

to be measured.

The method according to the first example comprises a step 410.

In step 410, the respective control variables c* and the measurement y*^{,i} assigned to the particular control variable c* are added to the data set D assigned to one another.

It can be provided to receive the measurements y*^{,i} individually or in a particular local data set.

It can be provided to add the respective local data sets to the data set D.

Subsequently, step 404 is executed again.

This means that when step 404 is executed again, the parameters of the hybrid model are learned with the data set D which 5 comprises the control variable c* and the measurements y*^{,i} assigned to the control variable c*.

It can be provided that parameters learned locally by the respective technical systems 108 are determined, and received by the device. It can be provided that the parameters of the hybrid model are determined according to the locally learned parameters.

What is claimed is:

1. A computer-implemented method for machine learning, the method comprising the following steps:
providing a data set, in which each respective measurement of an operating variable of a technical system including a noisy measurement of the operating variable, is assigned to a respective control variable of the technical system;
learning parameters of a hybrid model, which includes a hybrid differential equation, according to the data set, wherein the hybrid model includes a physical model and a data-based model, wherein the physical model is configured to determine a first part of a temporal change in the operating variable of the technical system, wherein the data-based model is configured to determine a second part of the temporal change in the operating variable of the technical system;
determining a control variable of the technical system according to a measure, which is dependent on the control variable, for an information gain in a measurement of the operating variable of the technical system when the technical system is operated with the control variable, and according to a probability that operation of the technical system with the control variable is safe; and
recording, during operation of the technical system with the control variable, a measurement of the operating variable assigned to the control variable, the control variable including a noisy measurement of the operating variable, wherein the control variable and the measurement assigned to the control variable are added to the data set, and wherein parameters of the hybrid model are learned with the data set to which the control variable and the measurement assigned to the control variable are added.

2. The method according to claim 1, wherein:
(i) the technical system includes a computer-controlled machine, the computer-controlled machine including: a robot or a vehicle or a household appliance or a motorized tool or a manufacturing machine or a personal assistance system, or an access control system, or
(ii) the technical system includes a test bench for a computer-controlled machine, the computer-controlled machine including a robot or a vehicle or a household appliance or a motorized tool or a manufacturing machine or a personal assistance system or an access control system.

3. The method according to claim 2, wherein the technical system includes the test bench, wherein the test bench is configured to test an internal combustion engine, wherein the internal combustion engine is configured to combust an air-fuel mixture according to the control variable, wherein the measurement assigned to the control variable characterizes an operating variable of the internal combustion engine including a noise emission or a pollutant emission of the internal combustion engine.

4. The method according to claim 3, wherein:
the internal combustion engine is configured to ignite the air-fuel mixture with a pilot ignition and a main ignition, wherein the control variable includes a time between a pilot ignition and a main ignition, and/or
the internal combustion engine is configured to provide fuel at a pressure in a distributor pipe of the internal combustion engine, wherein the control variable comprises the pressure, and/or
the internal combustion engine is configured to inject a quantity of fuel, wherein the control variable comprises the quantity of fuel.

5. The method according to claim 1, wherein the technical system is operable in a first operating state in which the technical system is used for an intended purpose according to the hybrid model, wherein the technical system is operable in a second operating state in which the technical system is not usable for the intended purpose, and wherein the control variable and/or the measurement assigned to the control variable and/or the data set that includes the control variable and the measurement assigned to the control variable, is determined in the second operating state.

6. The method according to claim 5, wherein the parameters of the hybrid model in the second operating state are learned with the data set that includes the control variable and the measurement assigned to the control variable.

7. The method according to claim 5, wherein, in the first operating state, a determination of the control variable, and/or the measurement assigned to the control variable, and/or the data set that includes the control variable and the measurement assigned to the control variable, and/or the learning of the parameters of the hybrid model with the data set that comprises the control variable and the measurement assigned to the control variable, is omitted.

8. The method according to claim 1, wherein the control variable is determined for which the measure for the information gain is greater than for another control variable and for which the probability that the operation of the technical system with the control variable is safe is greater than a threshold value.

9. The method according to claim 1, wherein the measure for the information gain includes a first matrix that includes a time series of measurements and a set of values of the change in the operating variable of the data-based model, wherein the control variable is determined according to a determinant of a second matrix, wherein the determinant of the second matrix approximates a determinant of the first matrix.

10. The method according to claim 9, wherein elements of the second matrix are defined by covariance of values of a change in the operating variable according to values of the time series.

11. A device for machine learning, comprising:
at least one processor; and
at least one memory;
wherein the at least one processor is configured to execute instructions, upon execution of which by the at least one processor, the device carries a method for machine learning, wherein the at least one memory (104) stores the instructions, and wherein the method includes:
providing a data set, in which each respective measurement of an operating variable of a technical system including a noisy measurement of the operating variable, is assigned to a respective control variable of the technical system,
learning parameters of a hybrid model, which includes a hybrid differential equation, according to the data set, wherein the hybrid model includes a physical model and a data-based model, wherein the physical model is configured to determine a first part of a temporal change in the operating variable of the technical system, wherein the data-based model is configured to determine a second part of the temporal change in the operating variable of the technical system,
determining a control variable of the technical system according to a measure, which is dependent on the control variable, for an information gain in a measurement of the operating variable of the technical system when the technical system is operated with the control variable, and according to a probability that operation of the technical system with the control variable is safe, and
recording, during operation of the technical system with the control variable, a measurement of the operating variable assigned to the control variable, the control variable including a noisy measurement of the operating variable, wherein the control variable and the measurement assigned to the control variable are added to the data set, and wherein parameters of the hybrid model are learned with the data set to which the control variable and the measurement assigned to the control variable are added.

12. A non-transitory computer-readable medium on which is stored a computer program for machine learning, the computer program, when executed by a computer, causing the computer to perform the following steps:
providing a data set, in which each respective measurement of an operating variable of a technical system including a noisy measurement of the operating variable, is assigned to a respective control variable of the technical system;
learning parameters of a hybrid model, which includes a hybrid differential equation, according to the data set, wherein the hybrid model includes a physical model and a data-based model, wherein the physical model is configured to determine a first part of a temporal change in the operating variable of the technical system, wherein the data-based model is configured to determine a second part of the temporal change in the operating variable of the technical system;
determining a control variable of the technical system according to a measure, which is dependent on the control variable, for an information gain in a measurement of the operating variable of the technical system when the technical system is operated with the control variable, and according to a probability that operation of the technical system with the control variable is safe; and
recording, during operation of the technical system with the control variable, a measurement of the operating variable assigned to the control variable, the control variable including a noisy measurement of the operating variable, wherein the control variable and the measurement assigned to the control variable are added to the data set, and wherein parameters of the hybrid model are learned with the data set to which the control variable and the measurement assigned to the control variable are added.
